(19) United States
(12) Patent Application Publication
(10) Pub. No.: US 2009/0021383 A1
(43) Pub. Date: Jan. 22, 2009

(54) METHOD FOR REDUNDANT CONTROL OF SERVICE INDICATOR LEDS

(75) Inventor: Enrique Q. Garcia, Oro Valley, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/778,263

(22) Filed: Jul. 16, 2007

(51) Int. Cl. G08B 21/18

(52) U.S. Cl. 340/641

(57) ABSTRACT

A lighting circuit for energizing an indicating light on a device coupled to a host, the circuit including a flasher circuit of the host; a fault detection circuit of the device; and an XNOR gate for receiving input from the flasher circuit and the fault detection circuit wherein the lighting circuit is adapted for energizing the indicating light and causing the indicating light to flash in the presence of a fault signal from the fault detection circuit

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The invention relates to the field of maintenance of electrical devices.

2. Description of the Related Art

Many computing systems, such as disk storage subsystems, generally use an amber or yellow light-emitting diode (LED) on a peripheral device to indicate a presence of error or fault conditions on the peripheral device. IBM's “Guiding Light” service protocol, for example, uses the amber LED as part of a strategy to identify and locate a field replaceable unit (FRU), such as the peripheral device, for repair or replacement by service personal and/or customers. With such a protocol, a host system can selectively flash the amber LED on any FRU to “identity” and bring attention to the FRU. A FRU itself can also light the LED if the FRU has a catastrophic error. The host with a flasher logic circuit output can be logically OR'ed with a fault detection logic circuit output on the FRU to energize an amber “Fault/Identify” LED on the FRU.

The FRU must have power in order to implement the OR'ing, and to power the LED itself. An equivalent implementation of the above circuit that does not rely on power to the FRU is depicted in FIG. 1. Referring to FIG. 1, a host 4 and an FRU 5 are included in a lighting circuit 3. The host 4 and the FRU 5 use, p-channel MOSFETs to create independent current sources. The current sources are OR'ed using diodes such that either can provide the current to power the LED. Even if the FRU 9 does not have power, the host 8 can still cause the LED to flash on the FRU 9.

A fundamental problem with the above circuits is that while the FRU 9 is energizing the LED on constantly (i.e., not flashing) due to fault detection, it is not possible for the host 9 to cause the LED to flash (i.e. LED cannot flash if the LED is already always on).

What are needed are techniques for energizing an indicator light to cause the indicator light to flash. Preferably, the techniques provide for overriding other signals that may cause a continuous on condition.

### SUMMARY OF THE INVENTION

The shortcomings of the prior art are overcome and additional advantages are provided through the provision of a lighting circuit for energizing an indicating light on a device coupled to a host, the circuit including a flasher circuit of the host; a fault detection circuit of the device; and an XNOR gate for receiving input from the flasher circuit and the fault detection circuit wherein the lighting circuit is adapted for energizing the indicating light and causing the indicating light to flash in the presence of a fault signal from the fault detection circuit.

Further disclosed is a method for energizing an indicating light on a device, the method including receiving a fault signal by an XNOR gate; and initiating flashing of the indicating light.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for allowing a host to energize an indicating light and override an output of a fault detection circuit in a field replaceable unit by a lighting circuit for energizing an indicating light on a device coupled to the host, the circuit including a flasher circuit of the host; a fault detection circuit of the device; and an XNOR gate for receiving input from the flasher circuit and the fault detection circuit wherein the lighting circuit is adapted for energizing the indicating light and causing the indicating light to flash in the presence of a fault signal from the fault detection circuit.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one prior art example of a lighting circuit that provides for powering an LED if power to an FRU fails;

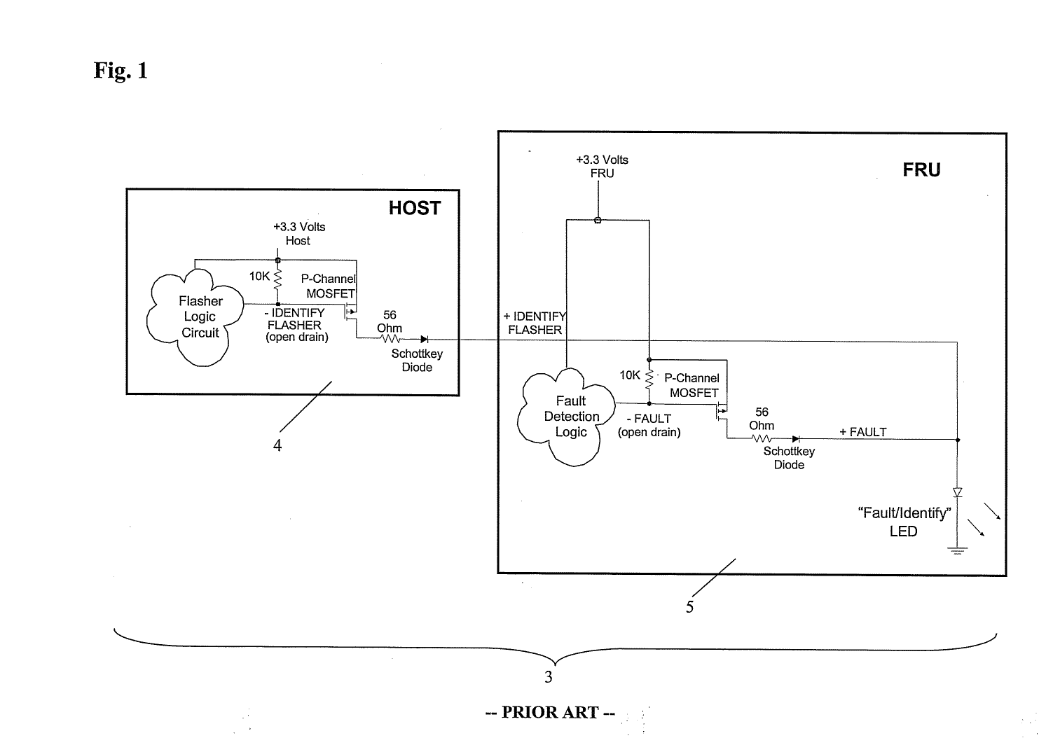

FIG. 2 illustrates one example of the lighting circuit providing for a host overriding the FRU in controlling the LED;

FIG. 3 illustrates an exemplary embodiment of the lighting circuit using

FIG. 4 illustrates an exemplary method for controlling the LED.

The detailed description explains the preferred embodiments of the invention, together with advantages and features, by way of example with reference to the drawings.

### DETAILED DESCRIPTION OF THE INVENTION

The teachings provide a lighting circuit and method for controlling an indicating light in a device such as a Field Replaceable Unit (FRU). The lighting circuit allows a remote unit to override the device in controlling the indicating light. For example, if the device detects a fault, the device will turn of the indicating light in a constant state. However, if at the same time, the remote unit decides to flash the indicating light, the remote unit will override the device and cause the indicating light to flash. The remote unit is generally remote to the device. The remote unit may provide for monitoring more than one device and may be referred to as a host. The device in one embodiment may be field replaceable and, therefore, may be referred to as a field replaceable unit (FRU). In general, flashing the indicating light indicates that the FRU needs replacing. Further, the lighting circuit supports the ability of the host to flash the indicating light even if the FRU does not have power. In some embodiments, the indicating light may be a light-emitting diode (LED) but the indicating light may include other types of lights.

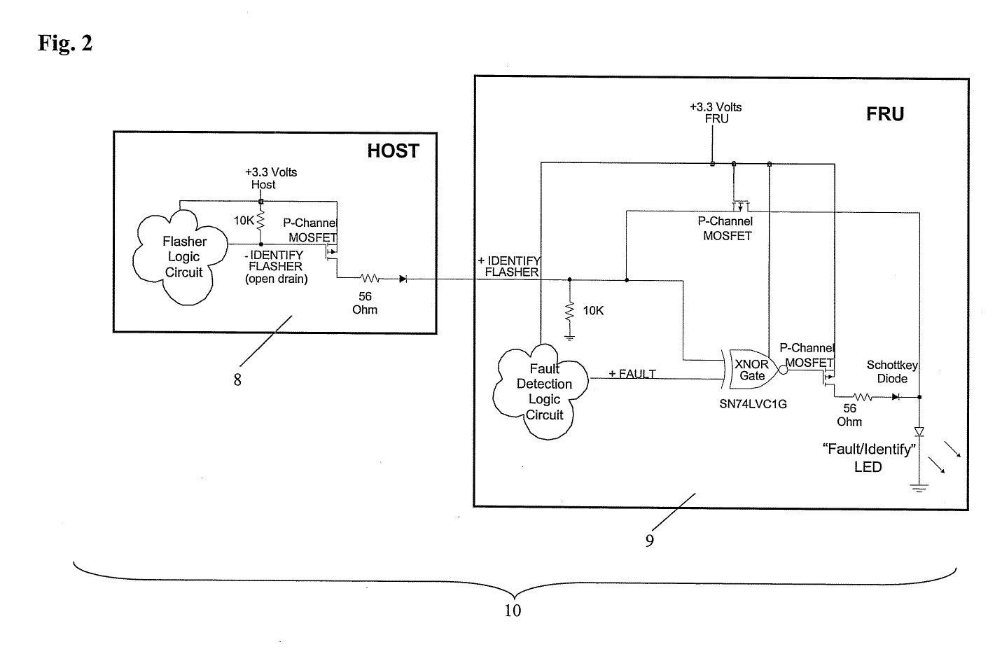

FIG. 2 illustrates an exemplary embodiment of a lighting circuit 10. The lighting circuit 10 provides for a host 8 to override an FRU 9 with respect to controlling a “Fault/Identify” LED. Further, the lighting circuit 10 provides for the host 8 powering the LED if power to the FRU 9 fails. Referring to FIG. 2, the FRU 9 implements a logical XNOR gate which is used to enable a p-channel MOSFET used to provide current to the “Fault/Identify” LED of the FRU 9. Logically, via the XNOR gate, if the FRU 9 asserts the “+FAULT” signal without the host 8 asserting a “+IDENTIFY FLASHER” signal, then the LED will be solidly illuminated. Logically, via the XNOR gate, if the host 8 flashes the “+IDENTIFY FLASHER” signal while the FRU 9 is not asserting its “+FAULT” signal, then the LED will be illuminated in a flashing state. Logically, if the FRU 9 asserts the “+FAULT” signal without the host 8 asserting the “+IDENTIFY FLASHER” signal, then the LED will be illuminated in a constant state. Logically, via the XNOR gate, if the FRU 9 asserts the “+FAULT” signal while the host 8 asserts the “+IDENTIFY FLASHER” signal, then the LED will be illuminated in a flashing state.

The XNOR gate must have the property that when the XNOR gate is not powered, inputs of the XNOR gate are in a high impedance state. In the high impedance state, the inputs do not drag down or otherwise affect circuitry connected to the inputs when power to the XNOR gate is removed off. As shown in FIG. 2, an example of the XNOR gate is a Texas Instruments SN74LVC1G57 available from Texas Instruments of Austin, Tex.

An additional p-channel MOSFET, operating as a switch, is included to selectively and completely bypass the logic (and an associated current sourcing MOSFET) of the FRU 9. The gate of the p-channel MOSFET switch is connected to the “+3.3V FRU” supply voltage. While the “+3.3V FRU” supply voltage is active, gate-source voltage of the MOSFET is biased such that the switch is open and current cannot flow between a drain and a source.

If the “+3.3V FRU” supply voltage is inactive, then the logic associated with the XNOR gate is high impedance and effectively removed from the circuit. While the “+3.3V FRU” supply voltage is inactive, the gate-source voltage of the MOSFET is biased such that the switch is closed and current can flow between the drain and the source. Therefore, when the “+3.3V FRU” supply voltage is inactive, the host 8 has a “direct” connection via the MOSFET switch to the LED through which the host 8 can provide current and flash the LED.

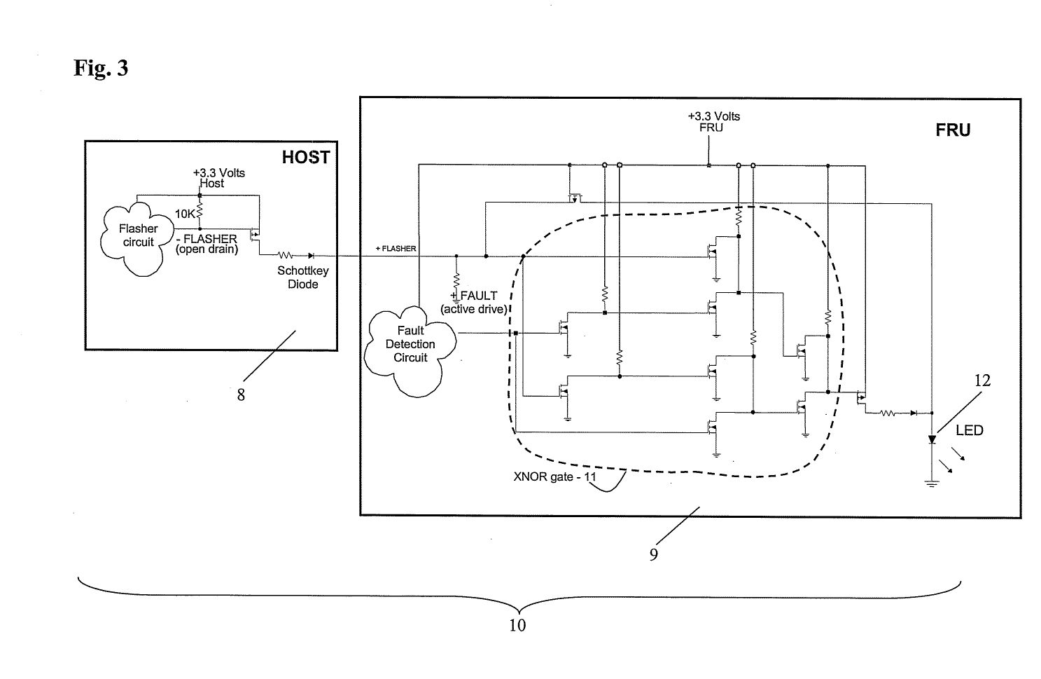

N-channel MOSFETs may be used for the XNOR gate in lieu of a single solid-state device. FIG. 3 illustrates an exemplary embodiment of the lighting circuit 10 using n-channel MOSFETs for the XNOR gate. As shown in FIG. 3, the lighting circuit 10 includes an XNOR gate 11 and an indicating light 12 (also referred to as LED 12).

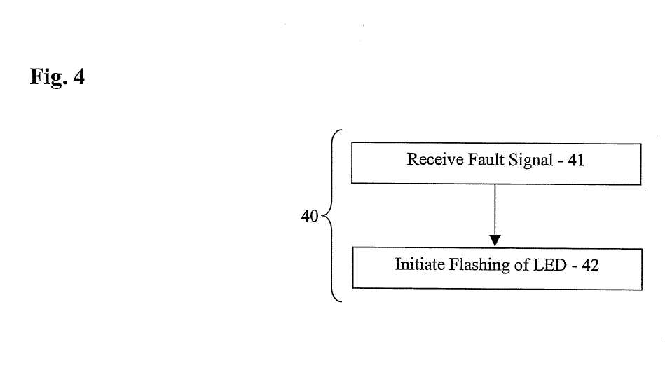

FIG. 4 illustrates an exemplary method for the host 8 to energize the LED 12. A first step 41 calls for the XNOR gate 11 receiving a fault signal. A second step 42 calls for the XNOR gate 11 initiating flashing of the LED 12.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A lighting circuit for energizing an indicating light on a device coupled to a host, the circuit comprising;
a flasher circuit of the host;
a fault detection circuit of the device; and
an XNOR gate for receiving input from the flasher circuit and the fault detection circuit wherein the lighting circuit is adapted for energizing the indicating light and causing the indicating light to flash in the presence of a fault signal from the fault detection circuit.

2. The circuit as in claim 1, further comprising a switch wherein the flasher circuit provides power to the indicating light through the switch when power is removed from the device.

3. The circuit as in claim 2, wherein the switch comprises a p-channel MOSFET.

4. The circuit as in claim 1, wherein the indicating light comprises an LED.

5. The circuit as in claim 1, wherein the XNOR gate comprises one solid-state device.

6. The circuit as in claim 1, wherein the XNOR gate comprises an n-channel MOSFET.

7. A method for energizing an indicating light on a device, the method comprising:
receiving a fault signal by an XNOR gate; and
initiating flashing of the indicating light.

8. A lighting circuit for energizing a light-emitting diode (LED) on a device coupled to a host, the circuit comprising:
a flasher circuit of the host;
a fault detection circuit of the device;
an XNOR gate comprising at least one n-channel MOSFET, the XNOR gate for receiving input from the flasher circuit and the fault detection circuit wherein the lighting circuit is adapted for energizing the LED and causing the LED to flash in the presence of a fault signal from the fault detection circuit; and
a switch comprising a p-channel MOSFET wherein the flasher circuit provides power to the LED through the switch when power is removed from the device.
